(19) United States
(12) Patent Application Publication
(10) Pub. No.: US 2008/0257993 A1
(43) Pub. Date: Oct. 23, 2008

(54) VENDING SHREDDER AND METHOD

(76) Inventors: MAURY D. COLE, Spring Valley, CA (US); Laurie L. Colum, Spring Valley, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 12/103,298

(22) Filed: Apr. 15, 2008

Related U.S. Application Data
(60) Provisional application No. 60/912,396, filed on Apr. 17, 2007.

(51) Int. Cl. B02C 1/08; B02C 4/00

(52) U.S. Cl. 241/243; 241/29

(57) ABSTRACT

A vending shredder which can be mounted to a wall or other structure or be free standing. This shredder functions much like a vending machine wherein the public can pay per minute to have paper shredded. This shredder can be manufactured in different sizes for example a small residential size can be used in a facility such as a apartment house or small business and a large size could be utilized in a mail box facility, post office or grocery store.

### CROSS-REFERENCE TO RELATED APPLICATIONS

This application claims the benefit of U.S. Provisional Patent Application Ser. No. 60/869,062, filed Apr. 17, 2007, entitled “Vending Shredder and Method” which is hereby incorporated by reference in its entirety.

### FIELD OF THE INVENTION

The present invention relates to shredders. More specifically this invention is a vending shredder where money can be inserted to purchase shredding time for the shredding of documents, CDs or DVDs. In some embodiments this vending shredder includes an option to purchase stamps, or display advertising.

### BACKGROUND OF THE INVENTION

Previously, a person who has paper that needs to be shredded for confidentiality or other purposes would either have to go to a shredding facility or purchase an expensive shredder to be housed in their business or at their place of residence. For persons who only have an occasional need for paper shredding this is cumbersome, very inconvenient and impractical. This invention and method solves these issues.

### SUMMARY OF THE INVENTION

The present invention involves a vending shredder which can be mounted to a wall or other structure or be free standing. This shredder functions much like a vending machine wherein the public can pay per minute to have paper shredded. This shredder comes in two variations; a small residential size and a large business size. This device is economical and can be purchased by the owner of a residential facility such as an apartment house, or a business establishment, such as a mail box facility, post office or grocery store.

This device overcomes the above-mentioned drawback in that it can be accessible to numerous persons and who can use it on an occasional basis. The user merely needs to pay for the allotment of time that it takes to shred the documents they desire. This shredder can either be connected to an existing power source or can be self contained and function off of a solar panel. This shredder is self oiling so that it is nearly maintenance free. This shredder is easily accessible so that it can be emptied by the owner. In addition to being capable of shredding paper this machine is also capable of shredding CDs or DVDs.

The purpose of this device is to make readily available in an industrial/commercial or residential location a solution for shredding paper on an occasional basis. The shredder can be used safely to dispose of unwanted mail or other documents in order to avoid identity theft. The primary way that identity is stolen is through mail. This device will assist in the prevention of identity theft. This device will eliminate the risk of those who have large or small quantities of private and personal information to be shredded but who do not have the capability to go to a shredding facility or purchase a shredder for their home or business. This device can be placed at convenient locations where the average consumer will be able to access and use the device. Some examples where the embodiment of this invention may be placed would be post offices, college campuses, apartment complexes, UPS Stores®, FedEx® locations, Kinkos® locations, laundromats, office buildings, Mail Boxes, Etc.® locations, and recycle centers.

The device will be manufactured with a very durable material preferably a metal or hard plastic. A digital menu on the face of the device will advise the user of the amount of shredding time they have left for the payment they have inserted into the machine. If the user desires more time to utilize the machine they can insert additional money. In one embodiment this digital menu can display advertisements. In a preferred large embodiment of this invention there would be a clear window or see through material over the front of the machine so the user will be able to visually see the shredded paper falling into the container. In larger embodiments of this invention the trash container would be able to hold 500 gallons or more of shredded paper and will contain a fold down trash compactor. The trash compactor will compact the shredded paper to allow additional space for shredded paper. The trash compartment of this shredder can be easily removed and replaced as it is positioned on sliding rails. This allows the machine to be emptied or maintained. Warning labels will be affixed to the visible surfaces of the machine advising users not to place fingers or other objects into the shredder feeding slot. This device may be optionally fitted with letter openers and a stamp purchase device. The letter openers can include advertising displayed on them. For safety purposes the device will also have an emergency shut-off system and a reverse button.

### BRIEF DESCRIPTION OF DRAWINGS

The accompanying drawings, which are incorporated in and constitute a part of the specification, illustrate embodiments of the invention and, together with the description, serve to explain the objects, advantages, and principles of the invention. In the drawings,

FIG. 1 is a perspective view of an embodiment of the vending shredder attached to a wall;

FIG. 2 is a top plan cross-sectional view of the of the vending shredder of FIG. 1;

FIG. 3 is a frontal cross-sectional view of the vending shredder of FIG. 1;

FIG. 4 is a side cross-sectional view of the vending shredder of FIG. 1;

FIG. 5 are expanded views of some of the component parts of the vending shredder of FIG. 1;

FIG. 6 is a perspective view of a second embodiment of the vending shredder;

FIG. 7 is an exploded view of the vending shredder of FIG. 6; and

FIG. 8 is a view into the interior of the vending shredder of FIG. 6.

### DESCRIPTION OF EMBODIMENT OF INVENTION

After reading this description it will become apparent to one skilled in the art how to implement the invention in various alternative embodiments and alternative applications. However, with all the various embodiments of the present invention described herein, it is understood that these embodiments are presented by way of an example only, and not limitation. As such, this detailed description of various alternative embodiments should not be construed to limit the scope or breadth of the present invention as set forth below.

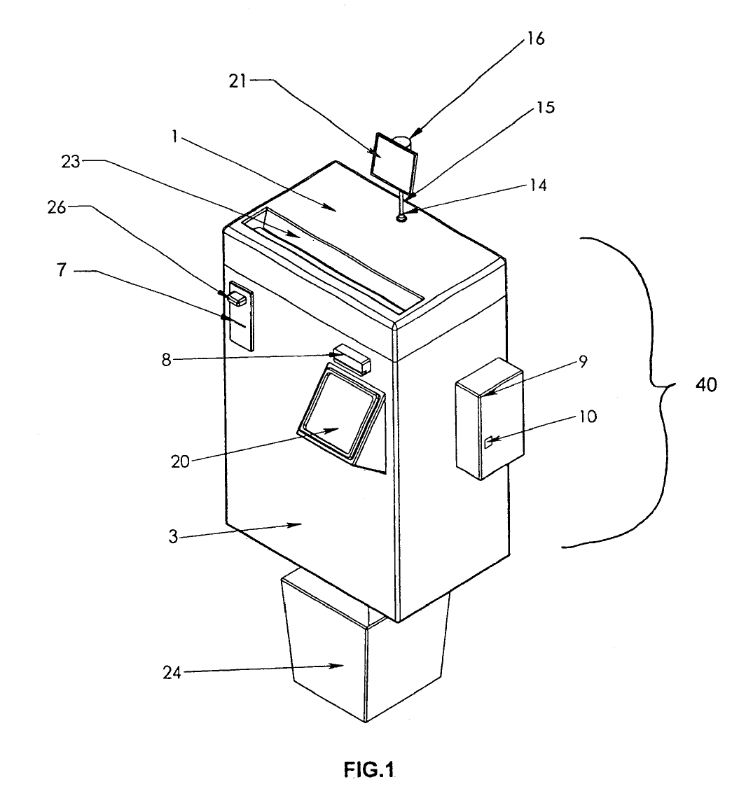

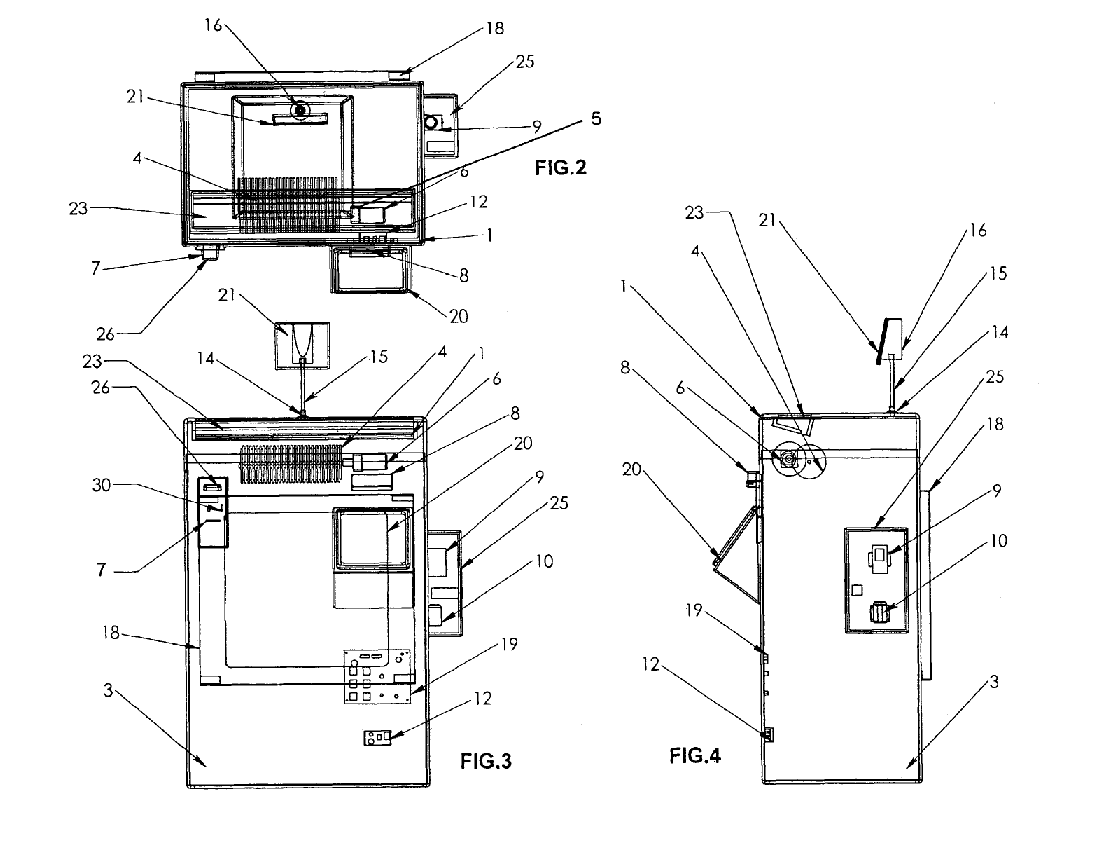

With reference to FIGS. 1-8 two embodiments and the component parts of a vending shredder 40 are shown. This shredder 40 is composed of at a minimum a housing, comprised of one or more parts; an access port 23 to feed the paper into; two or more cutting blades FIG. 2(4); a money 7 or card reader slot 8; a digital display 20, a power source, a motherboard 19 and an automatic oiling mechanism, comprised of oiler pump 9 and an oil container connecter 10. The vending shredder 40 can attach to a wall or solid surface or can be free standing. The vending shredder 40 accepts payment in return for time to shred paper, CDs or DVDs. Referring to FIG. 1, an embodiment of the wall mounted vending shredder 40 is shown and displayed. This embodiment has an upper housing 1 and lower housing 3 which fit and locks together. The upper housing 1 has four sides and a top and the lower housing 3 has four sides with an open bottom. Once the paper is shredded it drops from the upper housing 1 out thought the bottom of the lower housing 3 and into a trash container which can be placed below it. This embodiment is smaller in nature than the free standing embodiment and is manufactured to be placed at apartment complexes, dormitories, or other establishments wherein on average 5 to 200 persons will be using the machine per week.

The vending shredder 40 includes an access port 23 so that paper or DVDs can be fed into the machine for shredding. In a preferred embodiment the access port 23 allows paper with the maximum width of 16 to 20 inches to enter the access port 23. The wall mounted shredder FIG. 1 (40) can hold up to 10 pounds of computer paper and has a maximum capability to shred 45 sheets at a time. An internal restrictor plate which sits directly behind the access port 23 of the machine can be set so that a maximum of 10 sheets can be shredded at a time. This restrictor plate can be set manually. In order to set the restrictor plate the interior of the shredder 40 must be accessed by removal of the upper housing 1. In a preferred embodiment the plate is set by two screws at either side of the plate, when the two screws are loosened the plate can be pushed up or pulled down to reduce or enlarge the opening of the access port 23. The ability to regulate the amount of paper the shredder 40 will accept reduces the chance of the machine becoming clogged.

The vending shredder has a capability of being either electronically powered or solar powered. An embodiment which includes solar power has a solar panel 21 affixed to its surface. The solar panel is attached to an upper solar mount 16 which in a preferred embodiment sits upon a solar mount riser 15 attached to a solar mount 14. Other embodiments of this invention can be electronically charged by plugging them in to any electrical outlet.

The wall mounted embodiment of the vending shredder 40, shown in FIGS. 1-4, is essentially comprised of two housings fitted together. The upper shredding housing 1 composed of a top and four sides and the lower housing 3 composed of four sides and a bottom. One of the sides of the lower housing contains a money slot 7 and a card reader 8. The card reader 8 can be configured to accept credit cards or pre-purchased cards which contain money for shredding time. Additionally attached to one of the sides of the upper 1 or lower housing 3 is a digital menu and touch screen 20. This digital menu 20 allows the user to select the time they would like to shred and displays the payment needed and the time remaining once the shredder commences operation. This digital menu can also display advertising. Once the purchased shredding time has expired, an automatic door will close over the access port 23. A user will be able to insert additional money into the money slot 7, pay via the credit card slot 8, or insert a pre-paid shredder card to purchase additional time to shred documents. Once additional time is purchased the automatic door over the access port 23 will reopen and allow shredding to continue.

All embodiments of the vending shredder 40 come equipped with an auto-oiler mechanism including an oiler pump 9 and an oil container connecter 10. The oiler pump 9 and oil container connector 10 can be housed in a box on the exterior of the lower housing 3. This auto-oiler provides lubrication to the cutting blades internal in the shredder 40. In a preferred embodiment oil pump 9 will oil the blades of the shredder 40 at every tenth use. The shredder 40 will have an access panel at the back or top for maintaining and cleaning. The shredder machine 40 may also come equipped with a trash container 24 which can be affixed below or at the sides of the shredder 40.

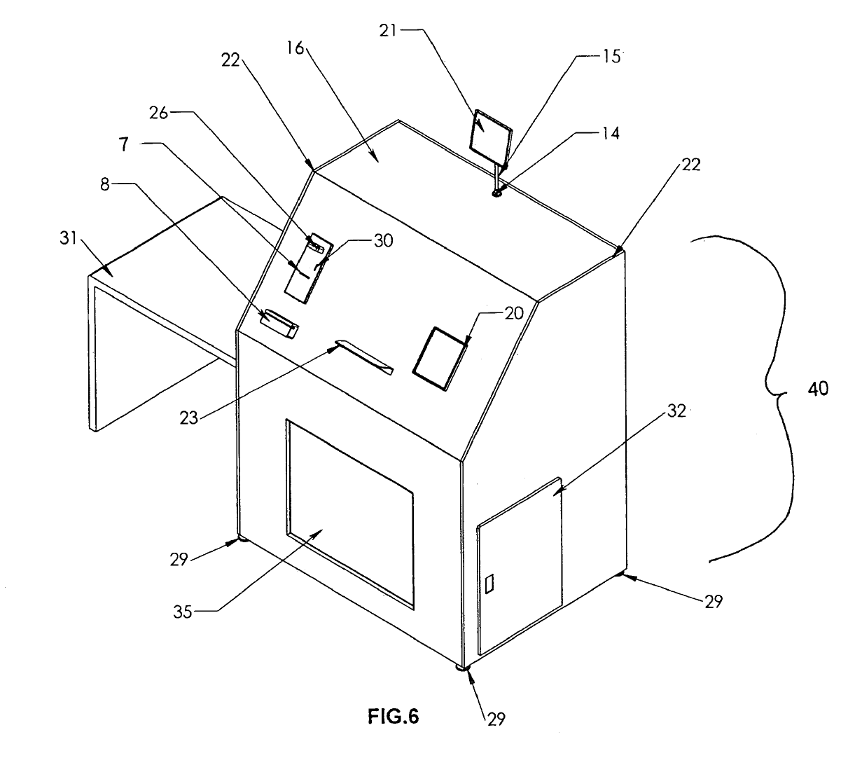

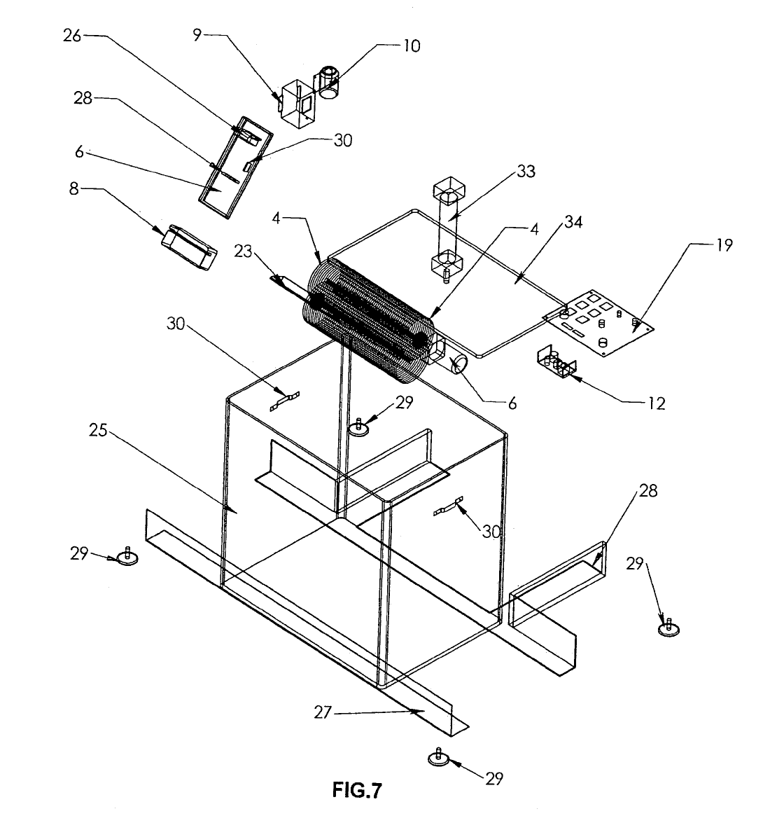

FIG. 2 is a top plan cross-sectional view of the vending shredder. Looking from the top down into the machine the cutting blades 4 can be seen. The shredder 40 contains two or more cutting blades. In the embodiment shown in FIG. 2 there are two circular cutting blades 4 which sit directly behind the access port 23. When the paper is fed to the access port 23 it is fed between the two cutting blades 4 which rotate independently of one another and shred the paper. The cutting blades 4 are turned by a motor 6 and a gear 5. In a preferred embodiment the motor size is 3.5 horsepower. The cutting blades 4 rotate in either the same or opposite directions of one another and slice the paper into thin shreds. The shreds of paper fall into the bottom of the machine into the lower housing 3 of the shredder 40. In a second embodiment of the shredder 40 which will be explained in more detail at FIG. 6-8 the paper can be compacted so as to allow increased room for additional paper.

Referring to FIG. 3 a motherboard 19 is affixed to one of the interior surfaces of the lower housing 3. This motherboard 19 controls the digital menu 20, which shows timing and money collection of the shredder 40 and coordinates the amount of time purchased with the running of the motor 5 and gears 6 to turn the blades 4. This digital menu 20 can also display advertisements. FIG. 4 is a side view displaying the oil pump 9 and the connection for an oil can 10. The oil pump is set on a timer to provide lubrication to the shredder blades 4 for at set interval of time. This interval of time can be set by the manufacturer or alternatively the user based on the use the machine will get at its particular location. The oil pump 9 and the oil can connector 10 can be placed either on the exterior of the lower housing or on any of the walls of the interior of the lower housing. The connection for the power supply 12 is also affixed to one of the lower walls.

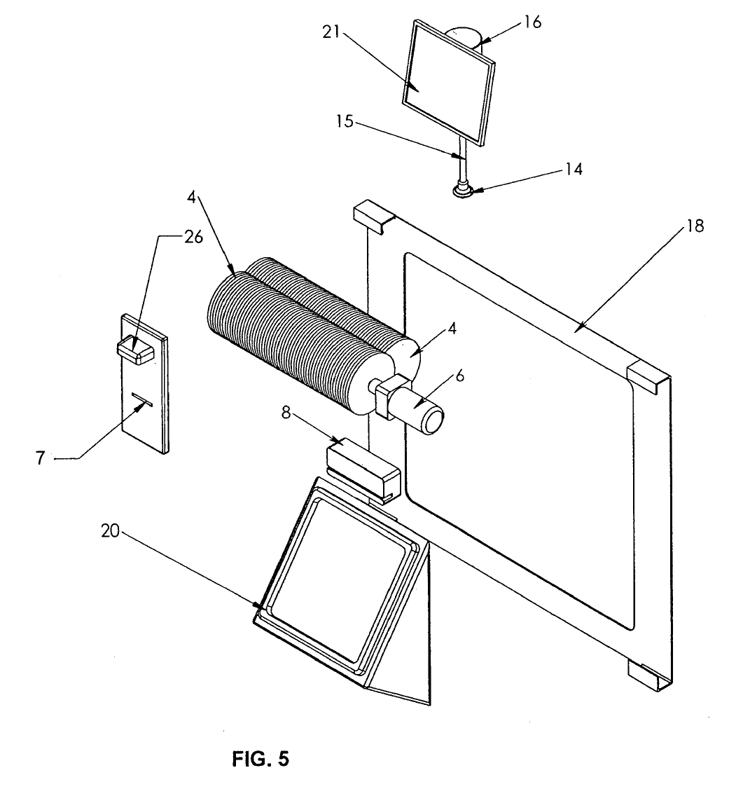

FIG. 5 are expanded views of some of the component parts of the vending shredder of FIG. 1. The vending shredder 40 comes with a mounting bracket 18. In a preferred embodiment this mounting bracket is manufactured of 20 gauge stainless steel, however in alternative embodiments this mounting bracket can be made from any other solid and durable material. The mounting bracket 18 can be manufactured with an opening so that the shredder machine fits within the opening or can be manufactured as a solid plate welded to the lower housing 3 of the vending shredder 40. The credit card reader 8 allows for a user to slide their credit card's or pre-purchased shredding card's magnetic strip and accesses the credit card information for payment for shredding time. The touch screen 20 is large enough to be visible from a distance of three feet to five feet and is placed on the exterior surface of the lower housing 4. In some embodiments of this invention a stamp dispenser 26 and letter opener can be placed on the surface of the lower housing. This stamp dispenser 26 allows the user to use the touch screen 20 to purchase stamps. The stamps are then disbursed through the stamp disbursement slot 26. In a preferred embodiment the money deposit slot 7 will accept one dollar bills, five dollar bills, twenty dollar bills or ten dollar bills. The machine will disburse proper change.

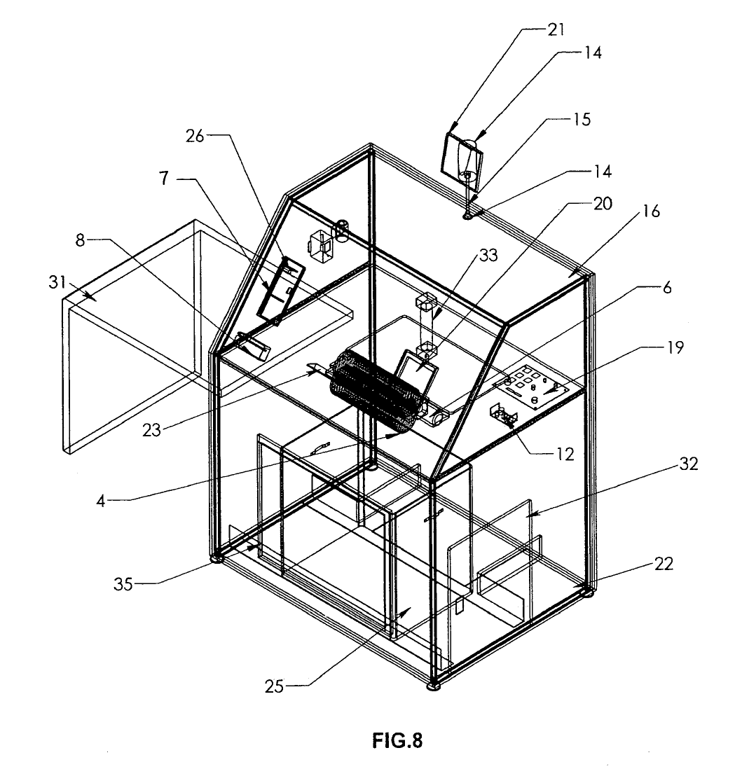

FIG. 6 is a perspective view of a second embodiment of the vending shredder. This embodiment of the vending shredder 40 is a larger machine which would be placed with high traffic such as post offices, college campuses, UPS Stores®, FedEx® locations, Kinkos® locations, laundromats, office buildings, Mail Boxes Etc.® locations, and recycle centers. A purchaser who envisions traffic at the rate of 200 or more persons per day. This embodiment of the machine has all of the features of the smaller version but has some additional added features. The paper feeds into the access port 23 front of this embodiment of the machine. The added features of this machine are the glass view panel 35, work table 31, guide rails FIG. 7 (27 and 28). This embodiment of the machine can be free standing so that it need not be affixed to a wall or other solid surface.

Referring to FIG. 7 the large embodiment of the shredder 40 also comes with a compactor piston 33 and a push plate 34 in order to compact the paper within the machine. In a preferred embodiment the size of this machine is 5 to 6 feet tall and 3 to 4 feet wide with a secondary level for handicapped users. The cutting blades 4 can also be configured to cross cut paper, DVDs and cds. In the cross-cut configuration three blades maybe used. The cross cut will be legal and approved by National Aeronautics and Space Administration. This machine will be equipped with a glass view panel FIG. 6 (35) on one of its sides so that the user will have a visual of the shredded documents. The lower housing 3 will be able to hold 500 gallons or more of shredded paper and contain a fold down trash compactor comprised of the compactor piston 33 and the push plate 34. This trash compactor will flip down and push the shredded paper to compact it creating additional space within the lower housing 3 for more paper. In a preferred embodiment the push plate 34 will be manufactured to be within a 16^{th} of an inch smaller than the circumference width of the lower housing 3. In order to retrieve the trash out of the shredder 40 there will be either an access door 32 to be placed on one of the walls of lower housing 3 or in the alternative the glass view plate 35 will come equipped with hinges to lock and unlock this opening.

The lower portion of the housing 3 which contains the trash can will be on sliding rails FIG. 7 (27 and 28) for easy removal of shredded paper. These sliding rails 28 and 29 can contain a locking mechanism so the machine cannot be removed without being unlocked from its attachment to the floor or other solid immobile structure. In one embodiment this machine can also include handles 30 which would be attached to either side of the housing 3. These handles 30 would be used to slide the machine on the lateral guide rails 27 so that it can be removed for emptying or repair. The shredder comes equipped with leveling feet 29, so that it can be properly positioned when it is installed.

The above description of disclosed embodiments is provided to enable any person skilled in the art to make or use the invention. Various modifications to the embodiments will be readily apparent to those skilled in the art; the generic principals defined herein can be applied to other embodiments without departing from spirit or scope of the invention. Thus, the invention is not intended to be limited to the embodiments shown herein but is to be accorded the widest scope consistent with the principals and novel features disclosed herein.

1. A vending shredder machine comprising:
a housing with four sides and a top;
two or more cutting blades which turn independent of each other and sit in the housing, the blades being configured to shred material which includes one or more of paper documents, DVDs and CDs;
an access port with an automatic door in one of the four sides or the top of the housing which accepts the material to be shredded and sits behind the cutting blades;
a motor and a gear configured to turn the two or more cutting blades;
a money slot and card reader configured to accept payment for shredding time;
a digital menu which allows the user to select an amount of time for shredding, displays the payment required and time remaining;
a motherboard configured to control the digital display and the motor;
a power source to power the cutting blades and digital display; and
an automatic oiling mechanism to provide lubrication to the cutting blades.

2. The vending shredder machine of claim 1, wherein the power source is solar.

3. The vending shredder machine of claim 1, wherein the power source is electrical.

4. The vending shredder machine of claim 1, wherein the digital menu displays advertising.

5. The vending shredder machine of claim 1, wherein one of the sides or part of one of the sides is clear enabling the user to visually see the shredded paper falling into the lower housing.

6. The vending shredder machine of claim 1, further including a trash compactor to compress the shredded paper.

7. The vending shredder machine of claim 1, which can be affixed to a wall.

8. The vending shredder machine of claim 1, which includes a stamp dispenser.

9. The vending shredder machine of claim 1, wherein the housing is composed of an upper and lower part.

10. The vending shredder machine of claim 1, further including a letter openers which can include advertising.

11. The vending shredder machine of claim 1, further including a compactor piston and push plate to compact the paper within the machine.

12. The vending shredder machine of claim 1, further including a trash container configured to collect the shredded paper.

13. A method of shredding material comprising:
providing payment to a shredding machine, the machine including a digital menu displaying the amount of time allotted for the shredding corresponding to the payment made; and
feeding one or more of paper, CDs and DVs into an access port located on the machine to be shredded by one or more blades contained within the machine.

14. The method of claim 13, wherein the machine is mounted to the wall.

15. The method of claim 13, wherein the digital menu also displays advertisements.

16. A vending shredder device comprising:
an upper housing with sides and a top;
two or more cutting blades which turn independent of each other and sit in the upper housing, the blades being configured to shred material;
an access port with an automatic door in one of the sides or the top of the upper housing which accepts the material to be shredded and sits behind the cutting blades;
an lower housing with sides configured to be affixed to a wall or other flat surface which connects with and locks to the lower housing;
a motor and gears configured to turn the two or more cutting blades;
a money slot and card reader configured to accept payment for shredding time;
a digital menu which allows the user to select an amount of time for shredding, displays the payment required and time remaining;
a motherboard configured to control the digital display and the motor; and
a power source to power the cutting blades and digital display.

17. The device of claim 16, further including a oiling device comprised of an oiler pump and oil container connector configured to oil the blades.

18. The device of claim 16, further including a stamp dispenser.
